(19) United States
(12) Patent Application Publication
(10) Pub. No.: US 2023/0225501 A1
(43) Pub. Date: Jul. 20, 2023

(54) A LIGHT-EMITTING EDGE COVERING DEVICE AND AN E-SPORTS TABLE COMPRISING THEREOF

(71) Applicant: DESIGNA INC., Foshan, Guangdong (CN)

(72) Inventor: Yajun HU, Foshan, Guangdong (CN)

(21) Appl. No.: 17/925,246

(22) PCT Filed: Jun. 18, 2020
(86) PCT No.: PCT/CN2020/096729

§ 371 Date: Nov. 14, 2022

(30) Foreign Application Priority Data
May 14, 2020 (CN) 202010407731.3

(51) Int. Cl. A47B 13/08; A47B 21/06

(52) U.S. Cl. CPC A47B 13/08; A47B 21/06; A47B 2200/008; A47B 2220/0075

(57) ABSTRACT

The present invention provides a light-emitting edge covering device, comprising an edge covering component and a light-emitting component for partially or fully covering an edge of a table top; the edge covering component comprises an upper edge covering component and a lower edge covering component for covering a bottom surface, a side surface and a top surface of the edge of the table top; the lower edge covering component is connected to the bottom surface of the edge of the table top, the upper edge covering component is connected to the top surface of the edge of the table top and the lower edge covering component; a connecting location of the upper edge covering component and the lower edge covering component is at a side of the edge of the table top, to achieve an edge covering of the side surface of the edge of the table top; the light-emitting component is provided inside the edge covering component. The light-emitting edge covering device can fully protect the edge of the table top to prevent the usual bumps. The present invention also provides an e-sports table comprising a light-emitting edge covering device. The e-sports table provides an anti-collision function, and has a light-emitting effect at the edge covering of the edge of the table top. This can greatly increase the sense of high technology and achieve promotion of the e-sports atmosphere, and is particularly suitable for use in e-sports as a sports platform.

### TECHNICAL FIELD

The present invention relates to the technical field of e-sports products, and more specifically, to a light-emitting edge covering device and an e-sports table comprising thereof.

### TECHNICAL BACKGROUND

E-sports (Electronic Sports) is a sports event of video game competitions that reach a “competitive” level. E-sports is the use of electronic devices as sports equipment to conduct intellectual confrontation between people. E-sports uses electronic devices as sports equipment to conduct intellectual confrontation between people. With the development and the rise of e-sports, more and more people have joined e-sports. Therefore, the demand for e-sports products increases continuously with the expansion of e-sports teams.

At this stage, in order to facilitate users' operation and experience in e-sports, related e-sports products have appeared on the market: e-sports chairs, e-sports earplugs, e-sports racks, etc. In the course of the competition, e-sports chairs in combination with ordinary computer tables will be used for conducting e-sports competitions. However, since both the table top and the table legs of the ordinary computer tables are not covered at the edges, it is difficult to prevent the usual bumps, and is unable to protect. In addition, the existing computer tables have the disadvantages of low structural stability and lack of sense of technology, which makes it difficult for e-sports players to heavily invest and concentrate energy in sports competitions, which affects the competitions of e-sports players.

### SUMMARY OF THE INVENTION

The purpose of the present invention is to overcome the shortcomings and deficiencies in the prior art, and to provide a light-emitting edge covering device with a simple structure and strong practicability. The light-emitting edge covering device can fully protect the edge of the table top to prevent usual bumps. The present invention also provides an e-sports table comprising a light-emitting edge covering device. The e-sports table has high practicability and a sturdy table top structure, and provides anti-collision function, and is particularly suitable for use in e-sports as a sports platform.

In order to achieve the above purpose, the present invention is achieved through the following technical solutions: a light-emitting edge covering device, characterized in that, comprising an edge covering component and a light-emitting component for partially or fully covering an edge of a table top; the edge covering component comprises an upper edge covering component and a lower edge covering component for covering a bottom surface, a side surface and a top surface of the edge of the table top; the lower edge covering component is connected to the bottom surface of the edge of the table top, the upper edge covering component is connected to the top surface of the edge of the table top and the lower edge covering component; a connecting location of the upper edge covering component and the lower edge covering component is at a side of the edge of the table top, to achieve an edge covering of the side surface of the edge of the table top; the light-emitting component is provided inside the edge covering component.

In the above solution, the light-emitting edge covering device of the present invention can protect the bottom surface, the side surface, and the top surface of the edge of the table top, and can fully protect the edge of the table top to prevent the usual bumps. The light-emitting edge covering device can use the upper edge covering component and the lower edge covering component to realize three-sided edge covering of the edge of the table top, which can reduce the edge covering process, improve the edge covering efficiency, and ensure the integrity of the covered edge of the table top. In addition, the light-emitting edge covering device is provided with a light-emitting component to provide it with a light-emitting effect, so that the table top using the light-emitting edge covering device can increase the sense of technology and achieve promotion of the e-sports atmosphere. The light-emitting edge covering device is particularly suitable to use for edge covering of competitive sports platforms for e-sports.

The upper edge covering component is formed by connecting an upper board connected to the top surface of the edge of the table top and an upper connection portion; a tile angle is provided between the upper board and a table top.

The lower edge covering component is formed by connecting a lower connection portion connected to the bottom surface of the edge of the table top and a lower board; the lower board is connected to the upper connecting portion of the upper edge covering component.

The tilt angle between the upper board and the table top can direct the emitting light concentrated toward the direction of the table top, and the lower board of the lower edge covering component and the upper board of the upper edge covering component are parallel to each other.

The upper edge covering component is provided with a light-emitting groove for the light-emitting component to emit light. The design can cause the concentration of the emitting light, and achieve a very good emitting effect.

The light-emitting component comprises a light-emitting unit inside the edge covering component; the light-emitting unit comprises a light-emitting source and a light guide for transmitting light; the light-emitting source is positioned on the light guide;

Or the light-emitting unit comprises a light-emitting source, a light guide for transmitting light and a light-guiding bar for transmitting light; the light-emitting source is connected to the light-guiding bar and is positioned on the light guide;

The light guide is connected to the lower edge covering component to fix the light-emitting component inside the edge covering component.

The present invention further comprises a control switch positioned on the upper edge covering component; the control switch is connected to a signal of the light-emitting source. The light-emitting source is electrically connected to an external power source, and on-off is provided through a control of the control switch.

The light-emitting component comprises two light-emitting units, the control switch is located between the two light-emitting units and is respectively connected to signals of the light-emitting sources of the two light-emitting units. The control switch is positioned between the two light-emitting units to facilitate wiring and facilitate the user to operate the control switch.

An e-sports table comprising a light-emitting edge covering device, characterized in that, further comprises a table top and a table leg connected to a bottom of the table top; the light-emitting edge covering device is provided on an edge of the table top, and covers a bottom surface, a side surface and a top surface of the edge of the table top.

In the above solution, the e-sports table of the present invention is provided with a light-emitting edge covering device, which not only can make the table top structure sturdy and provide an anti-collision function, but also has a light-emitting effect at the edge covering of the edge of the table top, which can greatly increase the sense of high technology and achieve promotion of the e-sports atmosphere, and is particularly suitable for use in e-sports as a sports platform.

The table leg is provided with a light-emitting device. The table leg is provided with several slots. The light-emitting device is embedded in the slots. The light-emitting device not only provides a warning function, but also can further improve the sense of technology of the e-sports table and achieve a promotion of the e-sports atmosphere.

The present invention further comprising a bracket; the bracket is provided at the bottom of the table top and is connected to the table leg;
further comprises a strengthening component; one end of the strengthening component is connected to the bracket and another end is connected to the table leg;
further comprises a base; the base is connected to an end of the table leg away from the bracket; a bottom of the base is provided with an adjusting feet for adjusting a height of the table top;
the bracket is an extendable bracket; the extendable bracket comprises an extendable slot and an extendable rack that respectively moves at both ends of the extendable slot; the extendable rack is connected to the table leg; both the extendable slot and the extendable rack are provided with fixing holes for position fixing.

A connection point of the table leg and the table top and a support point of the table leg and the ground are located on two sides of an axis of symmetry of the table top; the axis of symmetry of the table top is an axis of symmetry in a length direction of the table top;
the table top is provided with a wire outlet for arranging wires;
further comprises a storage bin; the storage bin is connected to a bottom of the table top, and is provided with a through hole for wire routing;
further comprises a keyboard tray device; the keyboard tray device comprises a keyboard tray, a connecting plate and a supporting arm; the connecting plate is connected to the bottom of the table top; the keyboard tray is hinged to the connecting plate through the supporting arm to allow a rotation of the keyboard tray; the keyboard tray is provided with a guard rail for preventing a keyboard from falling;
further comprises an item sorting rack, a mouse pad, a headset rack, a cup holder and an adjustable rack for holding a main computer; the mouse pad is flat on the table top, the item sorting rack is positioned on the table; and both the headset rack and the cup holder are positioned on a side of the table top;
the adjustable rack is located on the side of the table top, and comprises a rod, a support seat, and a clamp block that can be adjusted up and down the rod; one end of the rod is connected to the bottom of the table top, and another end is connected to the support seat; a space between the support seat and the clamp block serve as a clamping and placing space for the main computer;
further comprises a support leg and fasteners;
one end of the support leg is connected to the table leg through the fasteners, and another end is used to support the ground;
or one end of the support leg is connected to the table top, and another end is used to support the ground; the support leg is cross-connected to the table leg through the fasteners.

Compared with the prior art, the present invention has the following advantages and beneficial effects:

1. The light-emitting edge covering device of the present invention has a simple structure and strong practicability. The light-emitting edge covering device can fully protect the edge of the table top to prevent usual bumps.

2. The e-sports table of the present invention is provided with a light-emitting edge covering device, which not only can make the table top structure sturdy and provide an anti-collision function, but also has a light emitting effect on the edge covering of the edge of the table top, which can greatly increase the sense of high technology, and is particularly suitable for use in e-sports as a sports platform.

### BRIEF DESCRIPTION OF FIGURES

FIG. 1 is a first illustrative diagram of the e-sports table in the first embodiment;

FIG. 2 is a second illustrative diagram of the e-sports table in the first embodiment;

FIG. 3 is an illustrative diagram of a side surface of the e-sports table in the first embodiment;

FIG. 4 is an exploded view of the light-emitting edge covering device in the first embodiment;

FIG. 5 is an electrical connection diagram of the light-emitting edge covering device in the first embodiment;

FIG. 6 is an illustrative diagram of components of the e-sports table in the third embodiment;

FIG. 7 is an illustrative diagram of part of the e-sports table in the fourth embodiment;

FIG. 8 is an illustrative diagram of part of the e-sports table in the sixth embodiment;

FIG. 9 is an illustrative diagram of part of the e-sports table in the seventh embodiment;

wherein, 1 is light-emitting edge covering device, 1.1 is upper edge covering component, 1.2 is lower edge covering component, 1.3 is light-emitting source, 1.4 is light guide, 1.5 is light-guiding bar, 2 is table top, 3 is table leg, 4 is control switch, 5 is light-emitting device, 6 is bracket, 7 is strengthening component, 8 is wire outlet, 9 is base, 10 is adjusting feet, 11 is storage bin, 12 is extendable bracket, 12.1 is extendable slot, 12.2 is extendable rack, 12.3 is fixing holes, 13 is keyboard tray device, 13.1 is keyboard tray, 13.2 is connecting plate, 13.3 is supporting arm, 13.4 is guard rail, 14 is item sorting rack, 15 is mouse pad, 16 is headset rack, 17 is cup holder, 18 is adjustable rack, 18.1 is rod, 18.2 is support seat, 18.3 is clamp block, 19 is support leg, 20 is fasteners, and 21 is decorative components.

### DESCRIPTION

The present invention will be described in further detail below with reference to the figures and specific embodiments.

### First Embodiment

In this embodiment, a light-emitting edge covering device is used to partially cover edges at both sides of the table top as an example to describe the following.

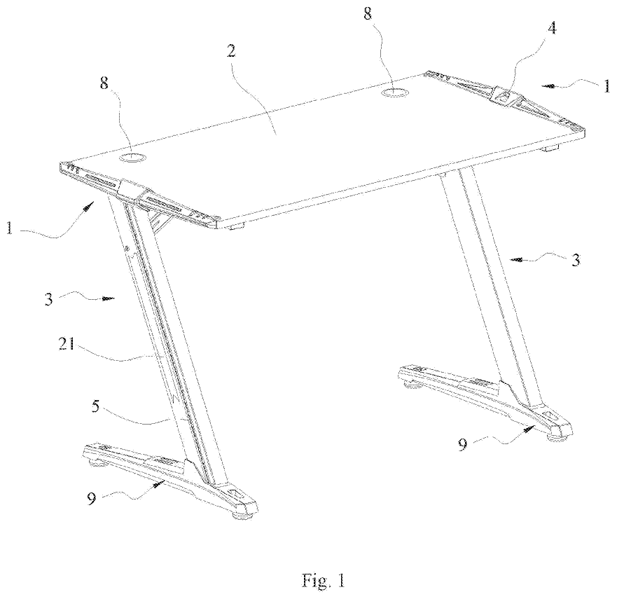

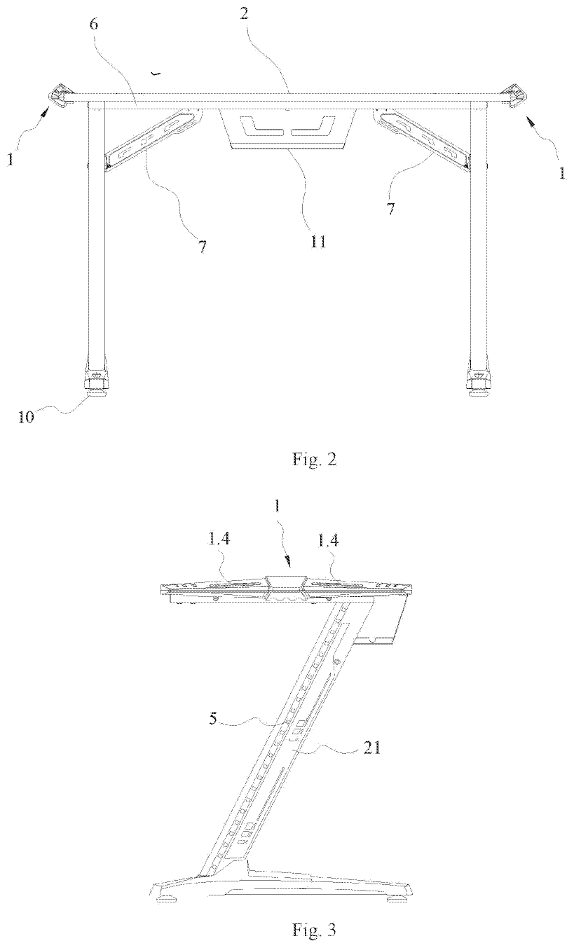

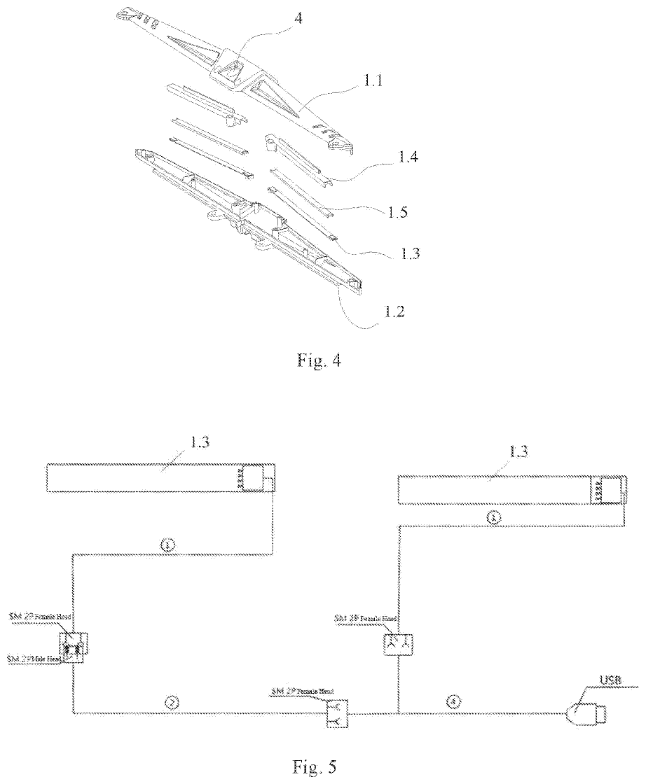

As shown in FIGS. 1 to 5, an e-sports table of the present invention comprises a light-emitting edge covering device 1, a table top 2 and a table leg 3 connected to the bottom of the table top 2, the light-emitting edge covering device 1 is positioned at edges at both sides of the table top 2 and covers the bottom surface, side surface and top surface of the edge of the table top 2.

The light-emitting edge covering device 1 of the present invention comprises an edge covering component and a light-emitting component for partially covering the edge of the table top 2, wherein the edge covering component comprises upper edge covering component 1.1 and lower edge covering component 1.2 for covering the bottom surface, side surface and top surface of the table top 2. The lower edge covering component 1.2 is connected to the bottom surface of edge of the table top 2. The upper edge covering component 1.1 is connected to the top surface of the edge of the table top 2, and is connected to the lower edge covering component 1.2. A connecting location of the upper edge covering component 1.1 and the lower edge covering component 1.2 is at a side of the edge of the table top 2, to achieve an edge covering of the side surface of the edge of the table top 2; the light-emitting component is provided inside the edge covering component.

Specifically, the upper edge covering component 1.1 is formed by connecting an upper board connected to the top surface of the edge of the table top 2 and an upper connection portion; a tile angle is provided between the upper board and a table top 2. The lower edge covering component 1.2 is formed by connecting a lower connection portion connected to the bottom surface of the edge of the table top 2 and a lower board; the lower board is connected to the upper connecting portion of the upper edge covering component 1.1.

The upper edge covering component 1.1 of the present invention is also provided with a light-emitting groove for emitting light from the light-emitting component. The light-emitting component of the present invention comprises two light-emitting units positioned inside the edge covering component. Both light-emitting units comprise light-emitting source 1.3, light guide 1.4 for transmitting light and light-guiding bar 1.5 for transmitting light. The light-emitting source 1.3 is connected to the light-guiding bar 1.5 and positioned on the light guide 1.4. The light guide 1.4 is connected to the lower edge covering component 1.2 to fix the light-emitting component inside the edge covering component. The light guide 1.4 emits light outward through the light-emitting groove.

The invention also comprises a control switch 4 provided on the upper edge covering component 1.1. The control switch 4 is located between the two light-emitting units of one of light-emitting edge covering device 1, and is respectively connected to signals of the light-emitting sources 1.3 of the two light-emitting units. The control switch 4 is positioned between the two light-emitting units to facilitate wiring, and facilitate convenient operation of the control switch 4 by a user. The light-emitting source 1.3 is electrically connected to an external power source, and the on-off is controlled by the control switch 4. As shown in FIG. 5, the light-emitting source 1.3 is electrically connected to an external power source via USB, specifically: one end of two wires (line \textcircled{1}) are respectively connected to the light-emitting source 1.3 of the light-emitting edge covering device 1 on both sides of the table top 2. The other end of the first wire (line \textcircled{1}) is connected to one of the plugs of the USB power cable (line \textcircled{4}) through an extension cord (line \textcircled{2}). The other end of the second wire (line \textcircled{1}) is connected with another plug of USB power cable (line \textcircled{4}). After the USB power cable (line \textcircled{4}) is connected to an external power source, on-off of light-emitting source 1.3 is achieved by controlling control switch 4 respectively. The present invention uses the 5V power supply serial connection resistor provided by USB to realize the voltage division and current limiting functions, and obtains a suitable voltage to power the light-emitting source 1.3.

The table leg 3 of the e-sports table of the present invention is provided with a light-emitting device 5, wherein the table leg 3 is provided with several open slots. The light-emitting device 5 is embedded in the open slots. The light-emitting device 5 not only provides a warning function, but also can further improve the sense of technology of the e-sports table and achieve a promotion of the e-sports atmosphere. In order to increase the uniqueness and beauty of the e-sports table, the table leg 3 is also provided with decorative components 21. Decorative components 21 are stickers with patterns, painted or screen printed with various patterns, or set with engraved patterns.

In order to improve the structural strength of the e-sports table, the e-sports table also comprises a bracket 6 and strengthening component 7, wherein the bracket 6 is provided at the bottom of the table top 2 and is connected to the table leg 3. One end of the strengthening component 7 is connected to the bracket 6. The other end is connected to table leg 3. In order to facilitate the wiring arrangement of the wires and to maintain the neatness of the table top, a wire outlet 8 for arranging the wires is provided on the table top 2.

The connection point of the table leg 3 and the bracket 6 and a support point of the table leg 3 and the ground of this embodiment are respectively located on two sides of an axis of symmetry of the table top 2, wherein the axis of symmetry of the table top 2 is an axis of symmetry in a length direction of the table top 2. This design can improve the stability of the support of table leg 3. The present invention further comprises a base 9. The base 9 of this embodiment is connected to the end of the table leg 3 further away from the bracket 6. The bottom of the base 9 is provided with adjusting feet 10 for adjusting the height of the tabletop. According to the present invention, the height of the table top 2 can be adjusted according to the adjusting feet 10. The table top 2, table leg 3 and base 9 form a “Z” shape, which can further improve the stability of the e-sports table.

The invention also comprises a storage bin 11. The storage bin 11 is connected to the bottom of the table top 2, and is provided with a through hole for facilitating wire routing. The storage bin 11 has three functions: first for storing items, second is that through holes are for easy routing, and the third is that the storage bin 11 is at the same side of the connection point of table leg 3 and bracket 6, which can provide a counterweight function.

### Second Embodiment

The difference between this embodiment and the first embodiment is only in that: the light-emitting edge covering device of the e-sports table of the present invention completely covers the edge of the table top.

The other structures of this embodiment are the same as those of the first embodiment.

### Third Embodiment

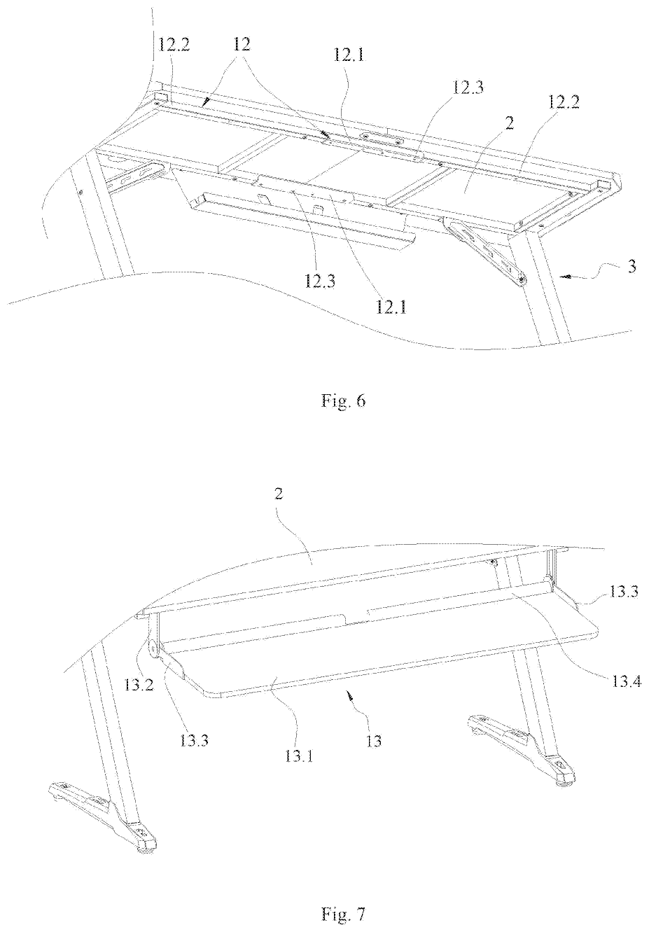

The difference between this embodiment and the first embodiment is only in that: as shown in FIG. 6, the bracket of the present invention is an extendable bracket 12. The extendable bracket 12 comprises extendable slot 12.1 and an extendable rack 12.2 that respectively moves at both ends of the extendable slot 12.1. Extendable rack 12.2 is connected to table leg 3 (light-emitting device not shown). Both extendable slot 12.1 and extendable rack 12.2 are provided with fixing holes 12.3 for position fixing with bolts or other fixing parts. In this embodiment, the extendable rack 12.2 can be extended to adjust the length of the table top 2. When the extendable rack 12.2 is extended and fixed in position, the table top 2 can be divided into two parts, which is convenient for two users to use the gaming table at the same time, thereby improving the practicality of the gaming table.

The other structures of this embodiment are the same as those of the first embodiment.

### Fourth Embodiment

The difference between this embodiment and the first embodiment is only in that: as shown in FIG. 7, the present invention further comprises a keyboard tray device 13. The keyboard tray device 13 comprises a keyboard tray 13.1, a connecting plate 13.2, and a supporting arm 13.3, wherein the connecting plate 13.2 is connected to the bottom of the table top 2. The keyboard tray 13.1 is hinged to the connecting plate 13.2 through the supporting arm 13.3 to allow a rotation of the keyboard tray 13.1. The keyboard tray 13.1 is provided with a guard rail 13.4 to prevent the keyboard from falling. The provision of keyboard tray device 13 is convenient for users to place the keyboard and to adjust the position of the keyboard according to the desired height. When the keyboard is tilted, it can also prevent the keyboard from falling due to the protection of the guard rail 13.4. Among them, the light-emitting device on the table leg is not shown.

The other structures of this embodiment are the same as those of the first embodiment.

### Fifth Embodiment

The difference between this embodiment and the first embodiment is only in that: the present invention also comprises an item sorting rack, a mouse pad, a headset rack, a cup holder and an adjustable rack for holding a main computer; the mouse pad is flat on the table top, the item sorting rack is positioned on the table; and both the headset rack and the cup holder are positioned on a side of the table top.

The adjustable rack of this embodiment is located on the side of the table top, and comprises a rod, a support seat, and a clamp block that can be adjusted up and down the rod. One end of the rod is connected to the bottom of the table top, and another end is connected to the support seat. A space between the support seat and the clamp block serve as a clamping and placing space for the main computer.

In this embodiment, the mouse pad can improve the user's comfort of using the mouse, and the item sorting rack, the headset rack, and the cup holder are convenient for the user to use, so to improve the convenience of use. The adjustable rack is versatile, and the clamping and placing space and can be adjusted according to the height of the main computer.

The other structures of this embodiment are the same as those of the first embodiment.

### Sixth Embodiment

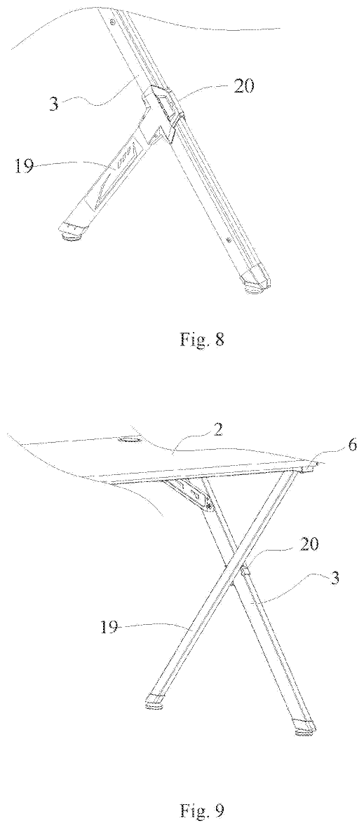

The difference between this embodiment and the first embodiment is only in that: as shown in FIG. 8, this embodiment does not comprise a base, and this embodiment further comprises a support leg 19 and fasteners 20. One end of the support leg 19 is connected to the table leg 3 through the fasteners 20, and another end is used to support the ground (Light-emitting device not shown). The other end is used to support the ground. The end of the support leg 19 in this way can be connected to the middle of the table leg 3, and provide the function of supporting the table leg 3.

The other structures of this embodiment are the same as those of the first embodiment.

### Seventh Embodiment

The difference between this embodiment and the sixth embodiment is only in that: as shown in FIG. 9, one end of the support leg 19 of this embodiment is connected to the bracket 6 and the other end is used to support the ground. The support leg 19 is cross-connected to the table leg 3 through the fasteners 20 (Light-emitting device not shown). The end of the support leg 19 in this way is connected with the bracket 6 and cross-connected with the table leg 3, and directly provides the function of supporting the table top 2.

The other structures of this embodiment are the same as those of the fifth embodiment.

### Eighth Embodiment

An e-sports table of this embodiment comprises a table top, a table leg at the bottom of the table top, and a light-emitting edge covering device, wherein the light-emitting edge covering device is provided on an edge of the table top, and covers a bottom surface, a side surface and a top surface of the edge of the table top. A light-emitting edge covering device of this embodiment comprises an edge covering component and a light-emitting component for partially or fully covering an edge of a table top. The edge covering component comprises an upper edge covering component and a lower edge covering component for covering a bottom surface, a side surface and a top surface of the edge of the table top, wherein the lower edge covering component is connected to the bottom surface of the edge of the table top, the upper edge covering component is connected to the top surface of the edge of the table top and the lower edge covering component. A connecting location of the upper edge covering component and the lower edge covering component is at a side of the edge of the table top, to achieve an edge covering of the side surface of the edge of the table top. The light-emitting component is provided inside the edge covering component.

The shape of the table leg can adopt existing table legs on the market, for example, a vertical table leg that can support the table top. The bottom of the table leg can also be connected to the body of the seat, etc., as long as it can firmly support the table top.

The light-emitting edge covering device of this embodiment can protect the bottom surface, the side surface, and the top surface of the edge of the table top, and can fully protect the edge of the table top to prevent the usual bumps. The light-emitting edge covering device can use the upper edge covering component and the lower edge covering component to realize three-sided edge covering of the edge of the table top, which can reduce the edge covering process, improve the edge covering efficiency, and ensure the integrity of the covered edge of the table top. In addition, the light-emitting edge covering device is provided with a light-emitting component to provide it with a light-emitting effect, so that the table top using the light-emitting edge covering device can increase the sense of technology and achieve promotion of the e-sports atmosphere. The light-emitting edge covering device is particularly suitable to use for edge covering of competitive sports platforms for e-sports.

The above embodiments are preferred embodiments of the present invention, but the embodiments of the present invention are not limited by the above embodiments. Any other changes, modifications, substitutions, combinations, simplifications etc. without departing from the spirit and principles of the present invention should all be equivalent replacement methods, which are all included in the protection scope of the present invention.

1. A light-emitting edge covering device, comprising an edge covering component and a light-emitting component for partially or fully covering an edge of a table top;
the edge covering component comprises an upper edge covering component and a lower edge covering component for covering a bottom surface, a side surface and a top surface of the edge of the table top; the lower edge covering component is connected to the bottom surface of the edge of the table top, the upper edge covering component is connected to the top surface of the edge of the table top and the lower edge covering component; a connecting location of the upper edge covering component and the lower edge covering component is at a side of the edge of the table top, to achieve an edge covering of the side surface of the edge of the table top; the light-emitting component is provided inside the edge covering component.

2. The light-emitting edge covering device according to claim 1, wherein the upper edge covering component is formed by connecting an upper board connected to the top surface of the edge of the table top and an upper connection portion; a tile angle is provided between the upper board and a table top;
the lower edge covering component is formed by connecting a lower connection portion connected to the bottom surface of the edge of the table top and a lower board; the lower board is connected to the upper connecting portion of the upper edge covering component.

3. The light-emitting edge covering device according to claim 1, wherein the upper edge covering component is provided with a light-emitting groove for the light-emitting component to emit light.

4. The light-emitting edge covering device according to claim 1, wherein the light-emitting component comprises a light-emitting unit inside the edge covering component; the light-emitting unit comprises a light-emitting source and a light guide for transmitting light; the light-emitting source is positioned on the light guide;
or the light-emitting unit comprises a light-emitting source, a light guide for transmitting light and a light-guiding bar for transmitting light; the light-emitting source is connected to the light-guiding bar and is positioned on the light guide;
the light guide is connected to the lower edge covering component to fix the light-emitting component inside the edge covering component.

5. The light-emitting edge covering device according to claim 4, wherein further comprises a control switch positioned on the upper edge covering component; the control switch is connected to a signal of the light-emitting source.

6. The light-emitting edge covering device according to claim 5, wherein the light-emitting component comprises two light-emitting units, the control switch is located between the two light-emitting units and is respectively connected to signals of the light-emitting sources of the two light-emitting units.

7. An e-sports table comprising a light-emitting edge covering device, wherein further comprises a table top and a table leg connected to a bottom of the table top; the light-emitting edge covering device is provided on an edge of the table top, and covers a bottom surface, a side surface and a top surface of the edge of the table top.

8. The e-sports table of claim 7, wherein the table leg is provided with a light-emitting device.

9. The e-sports table according to claim 7, further comprising: a bracket; the bracket is provided at the bottom of the table top and is connected to the table leg;
further comprises a strengthening component; one end of the strengthening component is connected to the bracket and another end is connected to the table leg;
further comprises a base; the base is connected to an end of the table leg away from the bracket; a bottom of the base is provided with an adjusting feet for adjusting a height of the table top;
the bracket is an extendable bracket; the extendable bracket comprises an extendable slot and an extendable rack that respectively moves at both ends of the extendable slot; the extendable rack is connected to the table leg; both the extendable slot and the extendable rack are provided with fixing holes for position fixing.

10. The e-sports table according to claim 9, wherein a connection point of the table leg and the table top and a support point of the table leg and the ground are located on two sides of an axis of symmetry of the table top; the axis of symmetry of the table top is an axis of symmetry in a length direction of the table top;
the table top is provided with a wire outlet for arranging wires;
further comprises a storage bin; the storage bin is connected to a bottom of the table top, and is provided with a through hole for wire routing;
further comprises a keyboard tray device; the keyboard tray device comprises a keyboard tray, a connecting plate and a supporting arm; the connecting plate is connected to the bottom of the table top; the keyboard tray is hinged to the connecting plate through the supporting arm to allow a rotation of the keyboard tray; the keyboard tray is provided with a guard rail for preventing a keyboard from falling;
further comprises an item sorting rack, a mouse pad, a headset rack, a cup holder and an adjustable rack for holding a main computer; the mouse pad is flat on the table top, the item sorting rack is positioned on the table; and both the headset rack and the cup holder are positioned on a side of the table top;
the adjustable rack is located on the side of the table top, and comprises a rod, a support seat, and a clamp block that can be adjusted up and down the rod; one end of the rod is connected to the bottom of the table top, and another end is connected to the support seat; a space between the support seat and the clamp block serve as a clamping and placing space for the main computer;
further comprises a support leg and fasteners;
one end of the support leg is connected to the table leg through the fasteners, and another end is used to support the ground;
or one end of the support leg is connected to the table top, and another end is used to support the ground; the support leg is cross-connected to the table leg through the fasteners.
